(19) United States
(12) Patent Application Publication
(10) Pub. No.: US 2006/0160603 A1
(43) Pub. Date: Jul. 20, 2006

(54) Video bingo game

(76) Inventor: Philip A. Lulek, Scottsdale, AZ (US)

Correspondence Address: GALLAGHER & KENNEDY, P. A., 2575 E. CAMELBACK RD. #1100, PHOENIX, AZ, 85016, US

(21) Appl. No.: 11/290,657

(22) Filed: Nov. 29, 2005

Related U.S. Application Data
(60) Provisional application No. 60/631,729, filed on Nov. 29, 2004.

(51) Int. Cl. A63F 13/00

(52) U.S. Cl. 463/19; 463/17

(57) ABSTRACT

A video gaming system combines multi-card bingo play with familiar and desirable entertainment elements such as spinning reels with fruit or other symbols. The game programming produces multiple bingo card representations on monitors at a plurality of game terminals. Drawn numbers (“balls”) are displayed one after another. An eight card bingo game pays a prize for a bingo win achieved on a card when less than a predetermined number of balls have been drawn and also when a cover-all or other predetermined game-ending pattern is achieved on a card that has not previously provided a prize affording win. A nine card eight line game displays bingo cards in a three-by-three grid. Prizes are awarded for pre-selected bingo wins accomplished in one of eight three-in-a-row patterns of cards running horizontally, vertically or diagonally. In the nine card, eight line game each winning card is associated with a symbol representative the bingo win. The symbol is presented by a representation of a spinning reel coming to rest at that symbol.

### CROSS REFERENCE TO RELATED APPLICATIONS

For common content herein, this application claims priority from the U.S. provisional patent application serial No. 60/631,729 entitled “Video Bingo Game” and filed on Nov. 29, 2004. That U.S. provisional application is incorporated herein by reference.

### FIELD OF THE INVENTION

This invention relates to video gaming systems and more particularly to a system of networked components for an electronic bingo game.

### BACKGROUND

Electronic or video bingo games have been known. These have been less than satisfactory from a player's point of view because only a single video card at a time can be played, whereas many bingo enthusiasts prefer to play several cards simultaneously.

Further, bingo video games available to date have lacked the entertainment features of other popular video casino games and so have been unexciting. An object of a new video bingo game is to impart the fun and excitement of other popular video casino games such as the ability to make multiple bets, the variety of multiple levels of prizes and the anticipation of watching multiple spinning reels of symbols.

### SUMMARY

In accordance with the present invention there is provided a system of video gaming that includes a networked central computer installation or server and a plurality of player terminals or client machines each of which displays and allows playing of multiple bingo cards. In addition, in preferred exemplary embodiments, sets of spinning, symbol-bearing reels are portrayed similar to those portrayed on popular, known video gaming machines.

In one preferred, exemplary embodiment of the invention, bingo cards achieve a “bingo win” by having a predetermined pattern of numerals that correspond to drawn numerals, or “balls” revealed one-at-a-time. If the “bingo win” pattern is accomplished before a certain number of the drawn numerals are drawn, a prize is given in a preferred embodiment. Cards that have not resulted in a prize winning bingo win after the predetermined number of drawn numbers have been revealed still can win a prize for a player by attaining a game-ending pattern. The game-ending pattern can be a cover-all pattern (with all numbers on the card corresponding to drawn numbers), or another predetermined pattern designated as game-ending.

In another preferred and exemplary embodiment of the invention, the player can choose to play, e.g., three, six, or nine cards at a single terminal. The player can select patterns of cards that, if they all result in bingo wins, will afford a prize. More particularly, the player can select lines of cards, for example lines of three cards each, extending horizontally, vertically and/or diagonally in a field of cards, so that cards with bingo wins completing one of the chosen rows in a particular fashion, say within a predetermined number of revealed drawn numerals, will achieve a prize.

An attractive feature of one embodiment of the invention, where a line of winning bingo cards achieves a prize, is the display of symbols that corresponds to each winning bingo card. Preferably the card display changes to a spinning reel of symbols stopping at the appropriate symbol when a winning card is achieved. Winning cards achieve varying levels of bingo wins depending on how early in the draw of numerals they achieve their winning pattern. Similar levels of wins are represented by similar symbols. In this way a row of three winning bingo cards displaying three spinning reels of symbols appears similar to familiar spinning reel casino games. Three wins of the same level might show, for example, three sevens in a row for a high prize. Other levels of wins can correspond to familiar symbols from other spinning reel games, e.g. three cherries, or other unique or arbitrary symbols. This game, then, can combine the enjoyment of multiple-card bingo play with the excitement and anticipation of spinning reel games.

The video screen displays the numerals or “balls” that are drawn for game play, the game number, the credits available to the player, the number of credits wagered in the game, the number of credits won if the player wins and notification when a player sleeps the bingo. The game can include on the display any other information which may be required and/or requested by a gaming facility and the controlling gaming authorities. Each embodiment of the games of the invention as configured complies with GLI-22.

Included on the player terminal is a pay table. This can be called up and viewed by the player. When a player achieves a winning pattern, the displayed symbols on the video screen correspond with illustration on the pay table.

The above and further benefits and advantages of the invention will be better understood from the following description of preferred, exemplary embodiments taken in consideration with the accompanying drawings. As used herein “numbers” and “numerals” are used interchangeably and have the same meaning. Drawn numerals or numbers are at times referred to as “balls” with no intended change in meaning.

### BRIEF DESCRIPTION OF THE DRAWINGS

FIG. 1 is a schematic illustration in block diagram form of a video gaming system in accordance with the present invention illustrating a game server computer and client or game terminal computer installations;

FIG. 2 is an illustration of the face of a player terminal of the system of FIG. 1 and shows a video monitor display of eight bingo cards available for simultaneous play;

FIG. 2A is an illustration of the game enhancing spinning reels displayed on a screen of a player terminal of the system of FIG. 1;

FIGS. 3A-3C is a flow chart illustrating the programming operating the game system of FIG. 1;

FIG. 4A is an illustration of a screen of a player terminal of the system of FIG. 1 operated in accordance with a further preferred embodiment of the invention with nine available bingo cards displayed in a grid providing an opportunity to win on any one of eight horizontal, vertical and diagonal lines;

FIG. 4B is an illustration of a screen of a player terminal of the system of FIG. 1 operated in accordance with the embodiment of FIG. 4A and shows the series of symbols or icons that are portrayed for each card having a bingo win;

FIG. 5 is a partial flow chart of programming for the embodiment of the invention displaying nine bingo cards and eight win lines;

FIG. 6A and 6B are a partial flow chart of features of a multicard bingo game requiring daubing of a bingo win; and

FIG. 7 is an illustration of exemplary winning bingo patterns for the nine card bingo game of FIGS. 4A and 4B.

### DETAILED DESCRIPTION

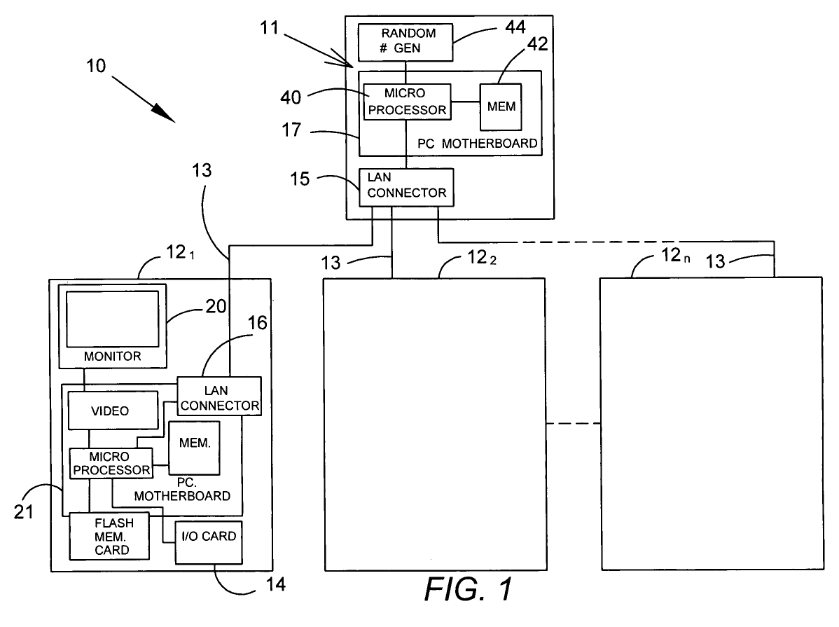

Shown in FIG. 1 is a networked video gaming system 10. The system includes a central computer or game server 11 in two way communication with a series of client computer player terminals 12₁, 12₂- - - 12ₙ. The communication links 13 between the central computer installation 11 and the terminals 12₁-12ₙ can be hardwired copper, optic cables or RF as desired. LAN connectors 15 and 16 are provided conventionally at the central installation 11 and the terminals 12₁-12ₙ to facilitate interconnection of the terminal and the central installation into a LAN. These provide electronic communications to and from the terminals 12₁-12ₙ and the server 11.

Each player terminal includes an input and output card 14 (or other means) for communicating with various player inputs as described below and to provide outputs to e.g. a voucher printer (not shown). A video display 20 may be a touch screen by which a player can operate the terminal and choose certain betting options described below. A commercially available PC motherboard 21 has processor, video and memory suitable to control operations of the terminal. One suitable such motherboard is commercially available from Desitron Corporation. Game play is governed by a programmed compact flash card mounted on the motherboard. These are commercially available from various sources.

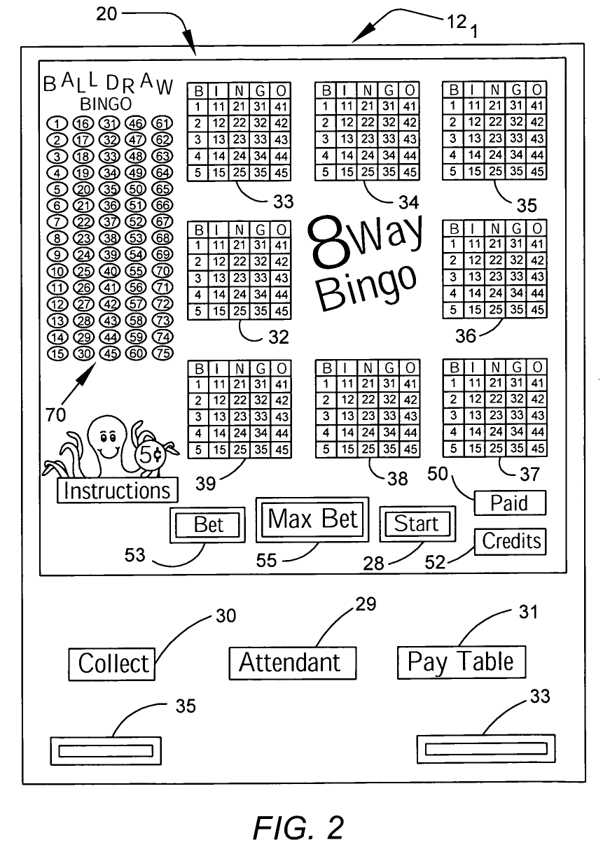

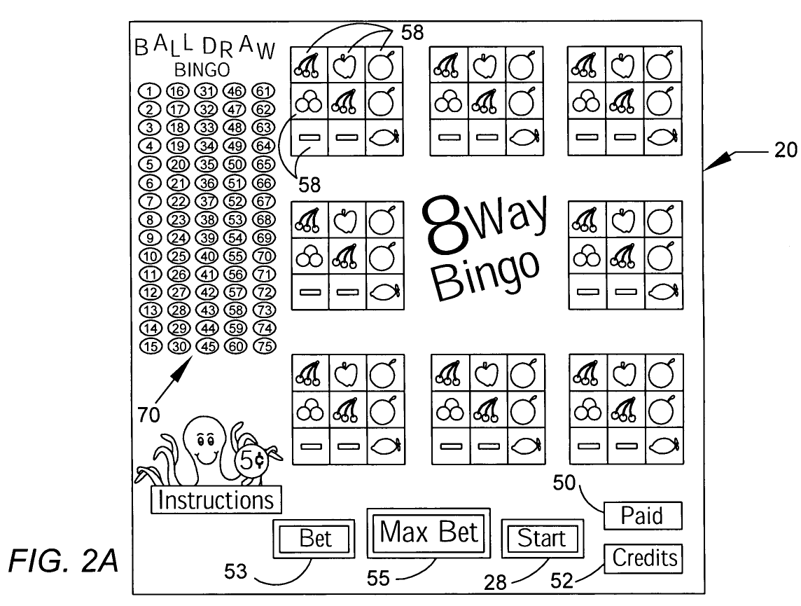

As shown in FIG. 2, the player terminals 12₁-12ₙ can include a start daub 28 as a touch screen feature and manually operable push buttons or touch pads 29, 30 and 31, for example, on the face of the cabinet. A currency acceptor 33 (or coin slot) can be provided, as well, on the face of the cabinet of the game terminal as shown in FIG. 2. A reader (not shown) for receiving a casino-issued card or ticket and/or a credit or debit card reader can be included (again not shown). Operated in connection with the push button or touch pad 30, a dispenser 35 dispenses a printed redeemable voucher upon activation of the collect feature by the button or pad 30. The printer (not shown) for that purpose is included in the terminal as is conventional. The button or pad 29 is one of conventional features provided, such as one used to summon an attendant. The push button or pad 31 causes the video monitor to display a pay table that lists the prizes for the various win categories.

The central computer 11 is equipped with a PC motherboard 17 (FIG. 1) with a processor 40 and such memory 42 (RAM and ROM) as is needed for programming and data manipulation, record-keeping and the like. A random number generator 44 is further provided in the game server 11 for use in generating randomly ordered sets of bingo card numbers and the randomly ordered and drawn numbers or “balls.”

The Eight Card Game

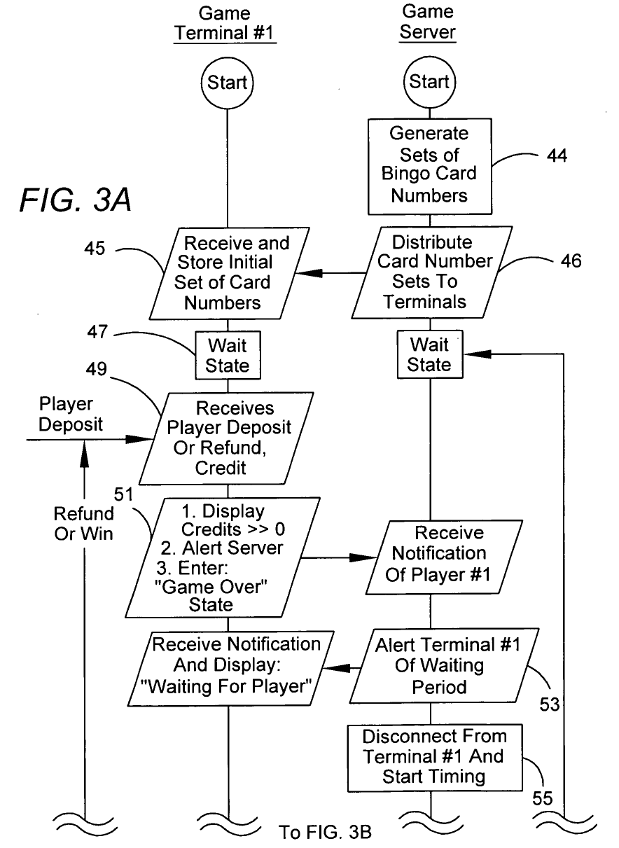

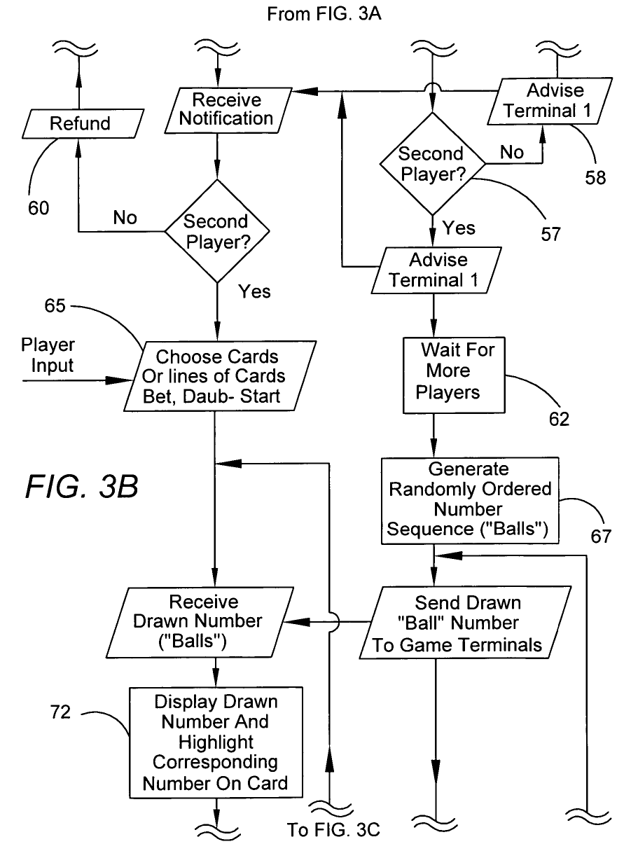

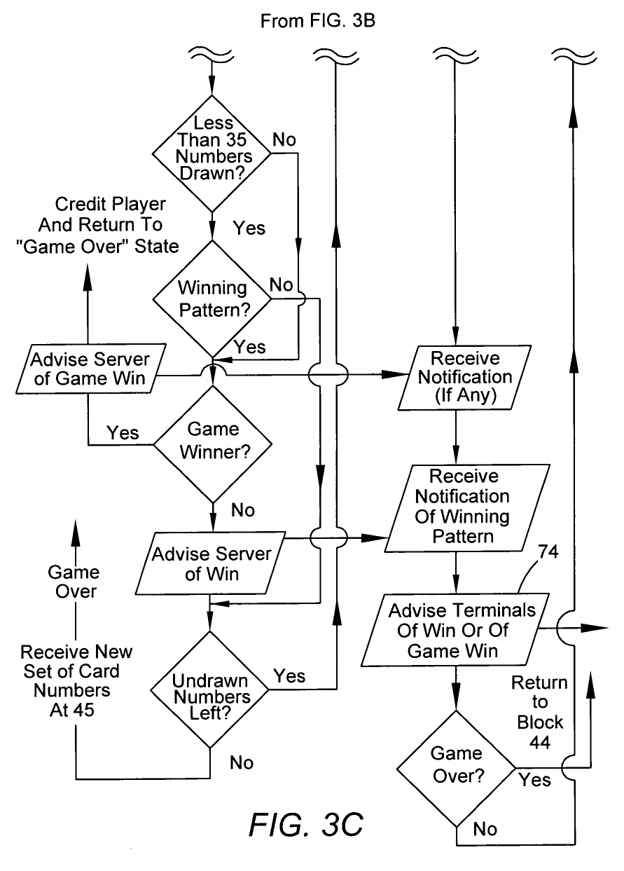

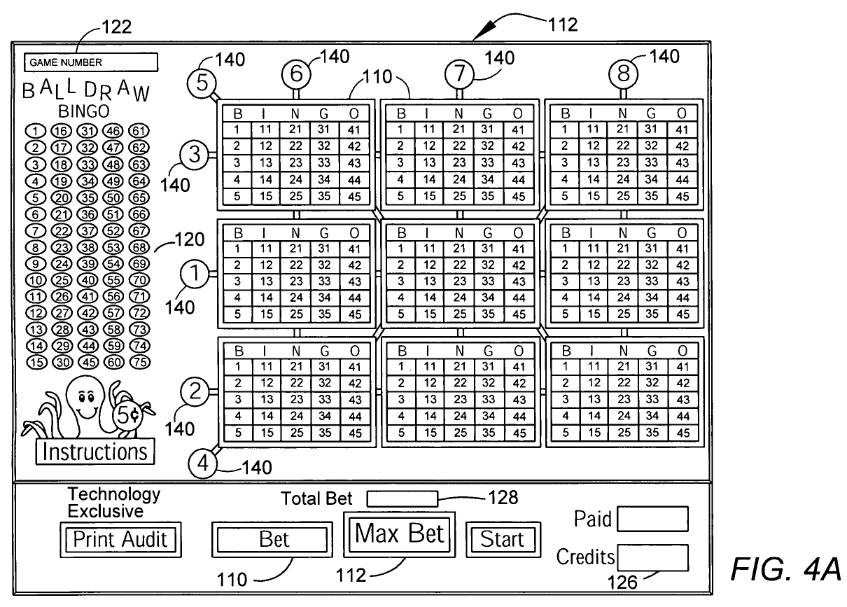

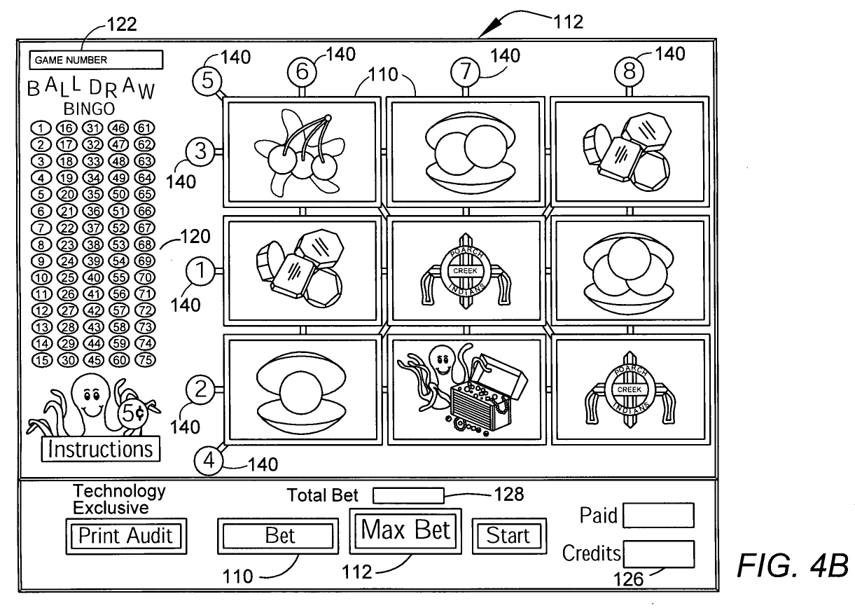

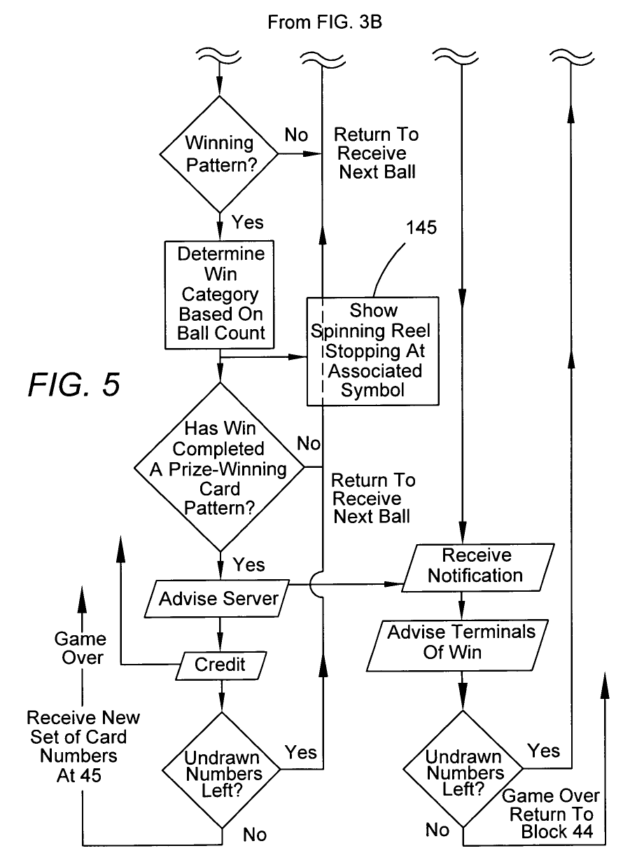

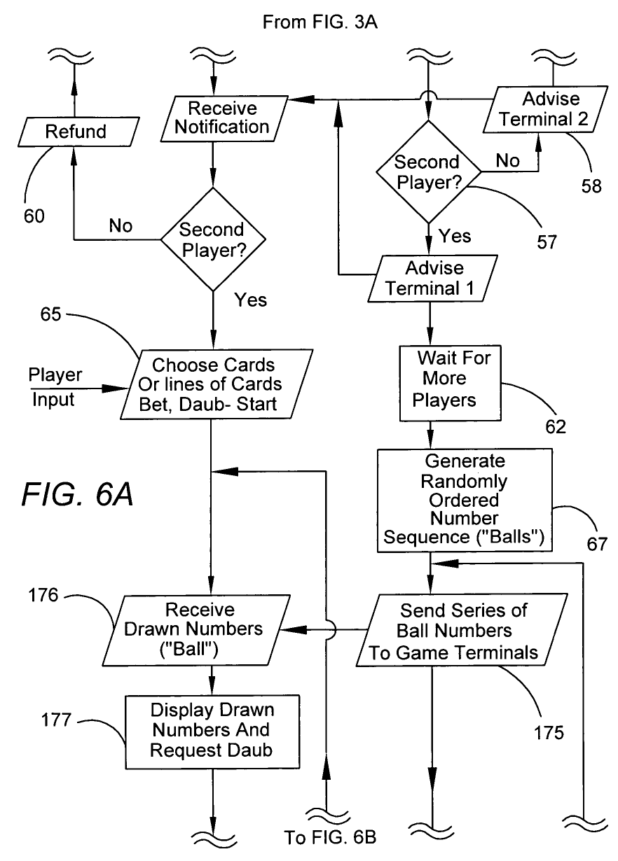

Referring to FIG. 2, in one exemplary embodiment, a player can select any number of the eight portrayed bingo cards to play. Selection is by either a touch of displayed cards, such as the cards 32-39 shown on a touch screen in FIG. 2, or by appropriately arranged buttons, or other known or convenient selection means. As shown diagrammatically at step 45 in the flow chart of FIG. 3, before a game begins the terminal 12₁-12ₙ receives from the server 11 eight bingo card number sets. Using the random number generator, the server 11 generates the card numbers at 44 for each server in the system prior to the start of any game. Number sets for eight cards are distributed to each terminal in the system at 46. Additional number sets are generated and stored in memory by the game server 11. Each number set is identified by a unique identifying number. These are retained in nonvolatile memory of the game terminal, for those received at the terminal, and at the server, so that if power is lost or a game terminal malfunctions the game can be restored.

Having received a first eight cards, a terminal waits in an initial, ready state at 47. When money or a card or ticket is inserted in a first of the terminals 12₁, at 49, credits are registered at 51 and the terminal alerts the server 11 and waits in a “game over” state with credits ready to be played. In the exemplary embodiments described here, if the value received by the terminal is cash, the terminal verifies the deposit, if the value is either a casino-issued card or ticket or a credit or debit card the server verifies the deposit.

The player terminals can be physically configured in a vast range of appearances. As presently embodied in the preferred embodiment, at 53 and 55 in FIG. 2, the player has the ability to bet from one cent ($0.01) to eight dollars ($8.00) on each bingo card played. Again this may be effected by a separate set of buttons or by active touch screen areas appropriately identified as shown. Additional graphics and features can be included as strictly entertainment provisions such as the graphics shown and the spinning reels described below.

Because the bingo games of the preferred embodiments described here are competitive games, a game does not proceed until two or more players are participating. When the player is ready to enter a game, the player must press the start daub 28 on the player terminal. The game of the exemplary eight card embodiment must be played with a minimum of two players through the central computer. If there are not enough players available to play the game initially, then at 53 the central computer 11 sets a display on the screen to advise the first player that it is waiting for another player to enter. After receiving an indication that a first terminal has received a deposit, the server disconnects from that terminal and starts at 55 a timed period of seconds, for example, during which it awaits a second player. After the timed period, if no additional player joins by making a deposit, the initial player is advised at 58 (FIG. 3B) at the first terminal and his/her deposit is made available at 60 for refund. If a second player joins within the timed period then, as indicated at 62, a further, shorter period may be allowed for additional players to join. After that further period play begins.

Each player can now bet, at 65, on one or more of the eight cards previously distributed to that player's terminal. Each bingo card in play will have twenty-five numbers randomly selected by the central computer 11. The numbers range from one to seventy-five in the exemplary embodiment. For each game, no two bingo cards issued among the players contain the same number configuration established by the central computer randomly. Once the player has chosen the number of bingo cards to be played, he or she can change the numbers on each card by either, say, a button or by touching the card displayed on the screen in the case of a touch screen display 20. A discarded number set will be restored to the pool of number sets available from the server and a replacement number set will be forwarded by the server to the particular terminal.

When the first player attempts to enter a game, the random number generator incorporated in the central computer system is used to generate the seventy-five numbered “balls” in rapid succession at 67. The numbers drawn in any one game are used in real time exclusively for that game, and are not for later use. The numbered bingo balls are revealed in the order in which they were generated. Each revealed number 1 through 75 is indicated at the display 20 in a field 70 shown in FIGS. 2 and 3. On the bingo cards 32-39 each number corresponding to a revealed, drawn number is shown by brightening or by change of color at 72 for example.

Multiple players' terminals are electronically linked to each other via the central computer so, for example, a win is announced among players as at 74. The preferred embodiment requires and promotes competition between players in the game of bingo. The computer system and player terminals readily comply with GLI-22.

The central computer generates up to the 75 randomly numbered “bingo balls.” The prize structure for the winning bingo patterns is based on the number of drawn numbers of bingo balls necessary to achieve that pattern. A player having a card completing a line across in fewer announced or revealed numbers will be awarded more credits than one who accomplishes “bingo” in this way after a greater number of ball numbers has been revealed. A player can view the prize table chart or pay table (not shown) at the player terminal by pressing the pay table button on the terminal. In a preferred embodiment prizes are awarded for achieving a winning bingo pattern (“a bingo win”) in less than 35 drawn numbers or “bingo balls.” In a preferred embodiment of the eight card bingo game, however, a prize is awarded and the game is ended whenever a game-ending pattern is achieved on a particular participating card that has not previously won a prize (even if 35 or more numbers have been drawn). A game-ending pattern may be a cover-all pattern, in which all of a card's numbers correspond to drawn numbers, thus covering the entire card. Alternatively, or in addition, a game ending pattern may be another predetermined pattern.

As mentioned, in the preferred exemplary embodiment of this eight card game, the video screen at each terminal will display spinning reels graphic symbols 58 that appear to rotate at times when the bingo game is played. If a player plays eight (8) bingo cards 32-39, eight (8) sets of spinning reels 58 will be displayed on the video screen. Each set of spinning reels will contain nine (9) individual reels with each reel having the ability to display up to ten (10) symbols. No other electronic video bingo game known to the inventor is capable of playing eight (8) bingo cards on the player terminal and is also so equipped to display additional graphics such as the spinning reels for each bingo card being played.

The spinning reels of the preferred exemplary embodiment are without effect on the bingo play. They serve to make the game more exciting and attractive. Alternately, the spinning reels may present a separate betting opportunity or opportunities to the player in the fashion of known video gaming machines.

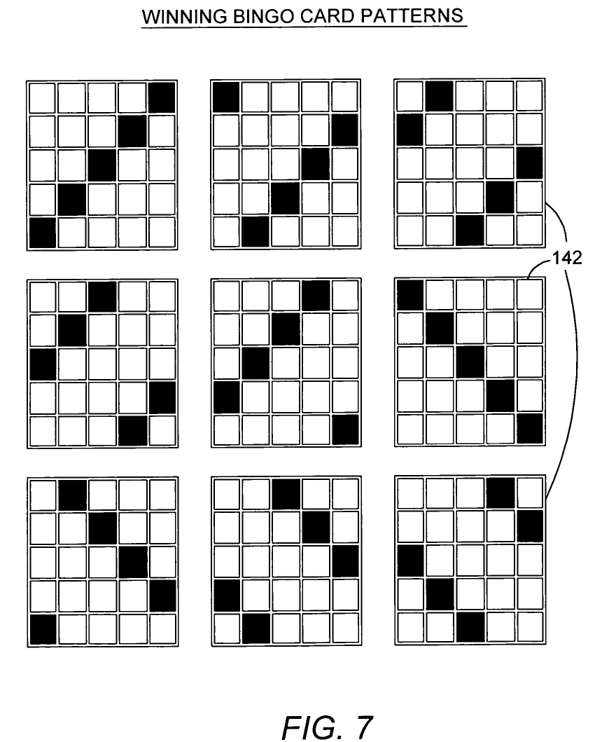

Winning bingo patterns may be five in a row horizontally or vertically or, as in the nine card embodiment described below, the six diagonal patterns illustrated at 142 in FIG. 7. Unless a game ending pattern is achieved a game is over when all seventy-five randomly generated “ball” numerals have been revealed.

Nine Card—Eight Way Bingo

A further, preferred and exemplary embodiment of a game in accordance with the present invention is a game called 9 Card -8 Way Bingo.™ That game also is played electronically on a networked system of components like those of FIG. 1. Again, players participate in the bingo games through the player terminals 12₁-12ₙ that can be physically configured in a vast range of appearances and that include the features described above in relation to FIGS. 1 and 2, but display a grid of nine bingo cards 110 as shown in FIG. 4.

The multiple player terminals 12₁-12ₙ are electronically linked to each other via the central computer platform or game server 11 as described. The 9 Card -8 Way Bingo™ game also requires and promotes competition between players in the game of bingo. This is again accomplished through the player terminals. The computer platform or server 11 and player terminals 12₁-12ₙ and their operations comply with GLI-22.

In this embodiment the game server 11 distributes bingo numeral sets for the nine bingo cards 110 displayed on the monitor display 112 in FIG. 4A. Like the displayed bingo cards of the preceding eight card game, the nine bingo cards each contain five vertical columns and five horizontal rows.

As described above, this bingo game also must be played with a minimum of two players through the central game server 11. The system requires that at least two players participate as described above, proceeding as illustrated in steps 44-62 of FIG. 3A and B. After two players enter a game, the enrollment period at step 62 for additional players to join the game starts. Here and in the preceding eight card game, this period may vary based upon the number of active player terminals. In that case the fewer the number of players, the longer would be the length of the enrollment period. After the enrollment period has expired, game play begins as at 65 in FIG. 3A.

At step 65 in FIG. 3A, in this game a player can choose one of eight “pay lines.” The eight pay lines are indicated at 140 in FIG. 4 and are numbered 1-8 on the display on the monitor 20. They are the three horizontal rows of cards (rows 1, 2 and 3), the three vertical rows of cards (rows 6, 7 and 8) and the two diagonal rows of cards (rows 4 and 5). If all eight pay lines are selected, then using the “bet” feature 110, the player is given the opportunity to increase the bet on any one line (for example up to eight credits), or by using the “Max Bet” activator 112 of FIG. 4, the player can play all eight lines at the maximum bet per line. The total bet is indicated at 128 in FIG. 4.

Here again, as previously described, players can change one or more of the originally distributed game cards before proceeding with the game. Each of the nine bingo cards in play have 25 randomly selected numbers displayed on the card. Again, like the preceding eight card game, for each game, no two game cards in play contain the same number configuration. After selecting his or her bingo cards, the player is ready to enter the game.

As in the previous eight card game the numerals drawn and displayed in sequence are shown on the display in a field 120 in FIG. 4. The field typically is at first blank with no numerals illuminated and the numerals are illuminated one-at-a-time until all 75 numerals or balls are exposed.

Winning bingo card patterns used in the exemplary embodiment of this nine card game are displayed at 142 in FIG. 7. Other patterns may be chosen as winning patterns. When numerals on the bingo card representations 110 are compared to and correspond to drawn numbers displayed in the field 120 in one of the winning patterns, then a “bingo win” has been achieved.

From step 72 in FIG. 3B, the nine card game proceeds as diagrammatically illustrated in the flow chart of FIG. 5. For each winning bingo pattern among the nine bingo cards, a particular symbol is assigned. The number of numeral draws or ball draws (“ball count”) to achieve the bingo pattern in each of the nine bingo cards determines the symbols to be assigned. When the bingo pattern is achieved the player is awarded at 145 in FIG. 5 a symbol determined by the amount of balls drawn to complete the pattern. An exemplary set of symbol assignments is set forth in Table I.

TABLE I

| Balls Drawn | Symbol Assigned |
|---|---|
| 1 to 42 | Seven |
| 43 to 50 | Bar |
| 51 to 57 | Bell |
| 58 to 64 | Plum |
| 65 to 70 | Orange |
| 71 to 72 | Cherry |
| 73 to 75 | Blank |

Available by touch of the pay table button 31 on the game terminal cabinet in FIG. 2, a pay table may be displayed. A typical pay table is as shown in Table II.

TABLE II
Winning Line Combinations

| | |
|---|---|
| 3 Sevens | Pays 100 for 1 |
| 3 Bars | Pays 75 for 1 |
| 3 Bells | Pays 50 for 1 |
| 3 Plums | Pays 20 for 1 |
| 3 Oranges | Pays 12 for 1 |
| 3 Cherries | Pays 10 for 1 |
| 3 Blanks | Pays 2 for 1 |

Of course, it is the pre-selected bingo wins along any of the eight lines within the predetermined number of draws that results in the prize award rather than a random occurrence of the symbols as in the typical spinning reel gaming machine. As will be evident, any of a huge variety of symbols may be used and many variations of pay tables may be chosen with their associated corresponding prizes provided in the software of the system.

A further opportunity for awarding prizes and increasing interest and excitement in the nine card bingo game is also provided. When all eight of the lines 140 are played high level prizes can be awarded based on multiple bingo wins beyond the three-in-a-row winning card pattern. An exemplary bonus prize schedule used in a preferred embodiment is shown in Table III.

Bonus Pays

Winning Window Combinations

9 of Any One Symbol Pays 2,500 for 1

8 of Any One Symbol Pays 250 for 1

7 of Any One Symbol Pays 50 for 1

Table III

To display the symbol associated with a particular bingo win, as indicated at 145 in FIG. 5, the video screen 20 at each player terminal will display spinning reel graphic symbols that appear to rotate. Spinning reel program routines are well known in the art. When a winning bingo pattern is achieved the animated sequence will come to a stop at its appropriate symbol. A monitor display 20 showing exemplary reel graphics in each of nine windows corresponding to the nine bingo cards is shown in FIG. 4B.

There is at least one winner for each bingo game. The animated sequence will never show the results of the bingo game (i.e. the assigned symbol) before the results are shown on the bingo card. The animated sequence has no effect on the outcome of the bingo game. The animated sequence is included on the video monitor solely for entertainment purposes.

If desired, or required by regulation or gaming authority rule, a player may be required to “daub” a win by touching a “collect” button 30 (FIG. 2) or a separate “start/daub” button (not shown) before being awarded his or her prize or prizes of additional credits. Also as discussed below daubing each winning bingo card may be required if desired or necessary.

Alternate Features

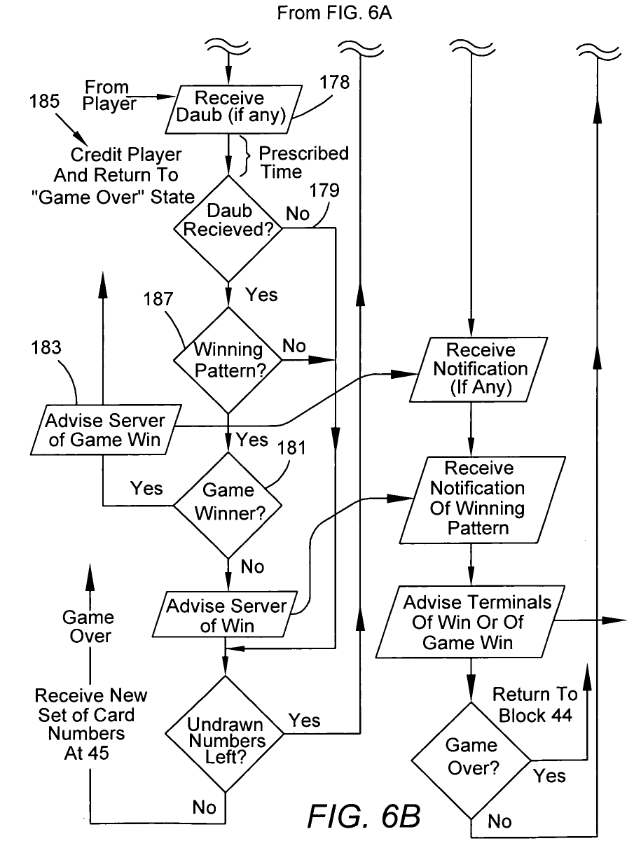

In an alternative embodiment the randomly generated numerals or “balls” are generated or revealed in several series as at 175 in FIG. 6A.. After each series of balls is revealed, each player may be required to cover their bingo card by daubing by touching a “play/daub” activator on the player terminal 12₁-12ₙ. The video screen cues all players to daub after each series of balls is revealed.

After at least two players have entered the game, and after the enrollment period has expired, the first series of balls is revealed at 175. A specific number of randomly generated balls are revealed simultaneously to each player in the first series at 177. After the first series of balls is revealed, a display on each player's terminal screen will prompt each player to daub (again at 177 in FIG. 6A). In the event any player fails to daub within a specifically defined amount of time as at 179 after the first series of balls is revealed, that player will have “slept” the bingo and will have forfeited any prize the player may have won. In this embodiment a player who has slept a bingo remains eligible to win but must obtain another winning pattern.

Next, after each player has either daubed or has slept the bingo by failing to daub within the allotted period of time, if there has been no game winning bingo win at 181 in FIG. 6B, the next series of the randomly generated balls will be revealed, at 175, 176 and 177, simultaneously to each player. A game-ending pattern is achieved when the first player obtains a coverall pattern or other designated pattern, and who then daubs that pattern.

After the first player obtains a game-ending pattern that player must daub at 178 within the specifically defined period of time. If that player daubs within the allotted time, the game ends at 183. However if that player fails to daub within the allotted time, that player will have slept the bingo. In the event no player daubs the game-ending pattern within the allotted time, the next player to obtain a game-ending pattern is required to daub before that game can end.

The first player to obtain a game ending pattern and who then daubs those numbers will win the bingo and will be awarded a prize as indicated at 185. The prize can be a percentage of the credits wagered on the game. However players do not need to be the first to obtain the game-winning pattern in order to be awarded a prize. A player may also obtain a predetermined winning bingo pattern during the course of the game as indicated at 187. Thus if a player obtains an interim winning bingo pattern (and daubs within the allotted time) in fewer balls than were necessary to be revealed before a player obtained the game ending pattern (provided that player also daubs within the allotted period of time), that player may be awarded an interim prize.

While particular preferred embodiments of the invention have been described, it will be understood that many modifications and variations in the bingo game of the invention may be made without departure from the spirit and scope of the invention as set forth in the appended claims.

I claim:

1. An electronic gaming machine terminal comprising:
(a) computer electronics including
(1) a processor;
(2) program-containing memory;
(3) electronic communications receiving and sending means for connecting the terminal in a local area network (LAN);
(4) a monitor;
(b) an acceptor for receiving a deposit of value from a player;
(c) at least one input device for a player to input to the computer electronics including:
(1) a bet designator;
(d) the program-containing memory including:
(1) programming responsive to sets of numerals received at the electronic communications receiving and sending means to display the sets of numerals in a plurality of bingo cards on the monitor;
(2) programming to compare to the sets of numerals displayed on the cards, for concurrence thereof, drawn numerals input to the electronic communications receiving and sending means;
(3) programming responsive to a pre-selected pattern of numeral concurrence on a displayed bingo card to register a bingo win.

2. The gaming machine terminal according to claim 1, wherein the displayed bingo cards are displayed on the monitor in a predetermined pattern, the programming responsive to a pre-selected pattern of numeral concurrence providing an indication of a bingo win to the electronic communications receiving and sending means.

3. The gaming machine terminal according to claim 2, further comprising programming responsive to bingo win indications for one or more cards in a pre-selected pattern of displayed bingo cards to designate a prize-winning pattern of winning card or cards.

4. The gaming machine terminal according to claim 3, wherein the pre-selected pattern of displayed bingo cards includes several rows of displayed bingo cards and completion of one or more of the rows with cards with bingo win patterns is designated a prize-winning pattern of winning cards.

5. The gaming machine terminal according to claim 4, including programming assigning each bingo win one of several symbols depending on the quantity of drawn numerals received prior to occurrence of the pre-selected pattern of numeral concurrence constituting the bingo win.

6. The gaming machine terminal according to claim 5, further comprising programming establishing a pay table setting forth prize awards and the assigned symbols for prize-winning patterns of bingo cards with bingo wins.

7. The gaming machine terminal according to claim 6, wherein the programming for displaying a plurality of bingo cards displays three rows of three cards each, the at least one input device comprising an interface input for use by a player to designate one or more of eight available horizontal, vertical and diagonal rows for a player to attempt to provide with bingo wins.

8. The gaming machine terminal according to claim 5, including programming displaying the assigned symbol at the location of each displayed card achieving the pre-selected pattern of numeral concurrence within a pre-selected number of drawn numerals.

9. The gaming machine terminal according to claim 8, wherein the programming displaying the assigned symbol displays a spinning reel of symbols stopping at the assigned symbol.

10. The gaming machine terminal according to claim 1, further comprising programming requiring that a player daub a winning displayed bingo card to obtain recognition thereof.

11. The gaming machine terminal according to claim 3, further comprising programming requiring that a player daub the pre-selected pattern of displayed bingo cards to obtain recognition thereof.

12. A gaming system including:
(a) a central computer installation;
(b) a plurality of gaming terminals interconnected with the central computer installation;
(c) the central computer installation having:
(i) a processor,
(ii) a random number generator, and
(iii) memory programmed with:
(A) programming for generating bingo card numerals and transmitting a plurality of sets of the bingo card numerals to each of a plurality of the gaming terminals for participating in a bingo game, and
(B) programming for generating a set of drawn bingo numerals and transmitting the set of drawn bingo numerals to each of the participating terminals;
(d) the plurality of gaming terminals each comprising:
(i) a display,
(ii) a processor, and
(iii) memory programmed with:
(A) programming for portraying the plurality of bingo cards bearing the bingo card numerals transmitted from the central computer installation,
(B) programming for displaying the drawn bingo numerals transmitted from the central computer display, and
(C) programming to indicate each concurrence of a numeral on a portrayed bingo card to one of the drawn bingo numerals.

13. The gaming system according to claim 12, wherein each terminal's programming further comprises:
(D) programming for identifying a winning pattern of concurring numerals on a displayed bingo card and transmitting a bingo win indication to the central computer installation.

14. The gaming system according to claim 13, wherein each terminal's programming further contains:
(E) programming recognizing a pre-selected winning pattern of displayed bingo cards with bingo wins.

15. The gaming system according to claim 14, wherein the programming for portraying the plurality of bingo cards portrays at least eight bingo cards in a grid on the monitor and the programming recognizing a pre-selected winning pattern of displayed bingo cards with bingo wins recognizes at least a horizontal or vertical row of cards with one or more bingo wins.

16. The gaming system according to claim 15, wherein the programming for portraying the plurality of bingo cards portrays at least nine bingo cards in a grid on the monitor and the programming recognizing a pre-selected winning pattern of displayed bingo cards with bingo wins recognizes one of eight horizontal, vertical and diagonal rows of three cards each with one or more bingo wins.

17. The gaming system according to claim 14, wherein the programming for generating a set of drawn bingo numerals and transmitting the set of drawn bingo numerals to each of the participating terminals causes transmission over time of the set of drawn bingo numerals in stages of subsets of one or more but less than all of the drawn bingo numerals, and wherein there is provided in one or more of said memories a prize schedule awarding prizes of graduated importance depending, at least in part, on how early in the display of the drawn bingo numerals a bingo win is accomplished on a displayed card.

18. The gaming system according to claim 17, wherein there is provided in one or more of the memories a symbol representative of the degree of importance of a bingo win on a card and programming for displaying the symbol in association with the card's position on the monitor.

19. The gaming system according to claim 18, wherein the programming for displaying the symbol displays the symbol by displaying a simulated rotating reel of symbols coming to rest at the symbol representative of the degree of importance of the bingo win on a card.

20. The gaming system according to claim 19, further comprising programming for awarding a graduated set of prizes increasing in value in dependence on the established degree of importance and number of bingo wins in a predetermined pattern.

21. The gaming system according to claim 20, wherein the programming for awarding a graduated set of prizes awards prizes of increasing value for bingo wins accomplished increasingly early in the transmission over time of the set of drawn bingo numerals.

22. The gaming system according to claim 13, further comprising programming requiring daubing at a terminal having a winning pattern of concurring numerals on a displayed bingo card to enable recognition of the winning pattern.

23. The gaming system according to claim 14, further comprising programming requiring daubing at a terminal having pre-selected winning pattern of displayed bingo cards with bingo wins to enable recognition of the winning pattern.

24. A method of video gaming comprising:
(a) providing a central, game server computer installation;
(b) providing a plurality of video gaming terminals in communication with the game server computer installation;
(c) portraying a plurality of bingo cards on monitors at the video gaming terminals;
(d) generating bingo card numeral sets at the central, game server computer installation,
(e) communicating a plurality of the bingo card numeral sets to each of the video game terminals participating in a video bingo game;
(f) populating the portrayed plurality of bingo cards of each participating video game terminal with the bingo card numeral sets communicated thereto;
(g) generating a randomly ordered set of drawn numerals at the central, game server computer installation;
(h) communicating the set of drawn numerals to participating video game terminals;
(i) comparing the numerals of the set of drawn numerals to the numerals of the bingo card numeral sets populating the portrayed bingo cards;
(j) identifying predetermined patterns of bingo card numerals concurring with numerals of the communicated set of drawn numerals as bingo winning patterns; and
(k) awarding at least one prize to a player at one of the participating video game terminals at which one or more portrayed bingo cards has established a bingo winning pattern of bingo numerals concurring with numerals in the set of drawn numerals.

25. The method of video gaming according to claim 24, wherein awarding at least one prize comprises awarding a prize when the bingo winning pattern is established before a predetermined number of the drawn numerals have been communicated to the video game terminals.

26. The method of video gaming according to claim 25, wherein awarding at least one prize further comprises awarding a prize for a pre-selected game ending pattern of bingo card numerals concurring with numerals of the communicated set of drawn numerals.

27. The method of video gaming according to claim 26, wherein the pre-selected game ending pattern is a cover-all pattern.

28. The method of video gaming according to claim 24, wherein step (c) comprises portraying at least eight bingo cards in a grid on a monitor and step (j) comprises identifying at least a horizontal or vertical row of cards with one or more bingo wins.

29. The method of video gaming according to claim 28, wherein step (c) comprises portraying at least nine bingo cards in a grid on a monitor, and further comprising identifying a pre-selected winning pattern of displayed bingo cards with bingo wins on one of eight horizontal, vertical and diagonal rows of three cards each.

30. The method of video gaming according to claim 24, wherein step (h) comprises transmission over time of the set of drawn bingo numerals in stages of subsets of one or more but less than all of the drawn bingo numerals, and providing a prize schedule awarding prizes of graduated importance depending, at least in part, on how early in the display of the drawn bingo numerals a bingo win is accomplished on a displayed card.

31. The method of video gaming according to claim 24, further comprising providing a symbol representative of the degree of importance of a bingo win on a card and displaying the symbol in association with the card's position on the monitor.

32. The method of video gaming according to claim 31, wherein displaying the symbol comprises displaying a simulated rotating reel of symbols coming to rest at the symbol representative of the degree of importance of the bingo win on a card.

33. The method of video gaming according to claim 31, further comprising providing a graduated set of prizes increasing in value in dependence on the established degree of importance and number of bingo wins in a predetermined pattern.

34. The method of video gaming according to claim 33, wherein providing a graduated set of prizes comprises awarding prizes of increasing value for bingo wins accomplished increasingly early in the transmission over time of the set of drawn numerals.

35. The method of video gaming according to claim 24, further comprising requiring daubing at a terminal having a winning pattern of concurring numerals on a displayed bingo card to enable recognition of the winning pattern.

36. The method of video gaming according to claim 29, further comprising requiring daubing at a terminal having a pre-selected winning pattern of displayed bingo cards with bingo wins to enable recognition of the winning pattern.
